(19) United States
(12) Patent Application Publication
(10) Pub. No.: US 2010/0321251 A1
(43) Pub. Date: Dec. 23, 2010

(54) Antenna elements, arrays and base stations including mast-mounted antenna arrays

(76) Inventor: Jan Hesselbarth, Dublin (IE)

Correspondence Address: Docket Administrator - Room 3D-201E;Alcatel-Lucent USA Inc., 600-700 Mountain Avenue, Murray Hill, NJ, 07974, US

(21) Appl. No.: 11/541,134

(22) Filed: Sep. 28, 2006

(51) Int. Cl. H01Q 1/12; H01Q 1/24; H01Q 21/00

(52) U.S. Cl. 343/702; 343/890; 343/893

(57) ABSTRACT

An antenna element 1 comprises a surround 2 of substantially circular cross-section and a plurality of feed sections 3, 4, 5 and 6 electrically connected to the surround 2. The feed sections are extensive substantially radially and inwardly from it. The surround may be cylindrical in other embodiments. The antenna element may be fabricated as single, integral component, for example, from metallized plastic using injection molding. The antenna element may be arranged to be frequency selective for transmit and receive, which is particularly applicable where it is incorporated in an antenna array used in a base station of a wireless communications system.

### FIELD OF THE INVENTION

The present invention relates to antenna elements, to antenna arrangements including an array of antenna elements and to wireless communications base stations including mast-mounted antenna arrays.

### BACKGROUND OF THE INVENTION

Antennas used in wireless communications base stations are generally mounted on a mast to achieve maximum coverage. If antennas are used for both transmission and reception of signals, some protection must be provided to ensure that receiving components are not damaged by transmitted signals of relatively high power. Alternatively, separate antennas can be used for transmission and reception, but, depending on their physical separation, a fraction of the transmitted power will still reach the receive path. Therefore, protection of the sensitive receive electronics remains necessary.

At the radio-frequency (RF) front-end of full-duplex, frequency division duplex (FDD) communication systems, high power transmit signals are prevented from leaking into the receive path by bandpass filters. Usually two bandpass filters are used having adjacent passbands. One filter passes the transmit frequency band only and the other filter passes the receive frequency band only. The two filters constitute a duplexer, which is connected between the amplifiers and the antenna. The frequency selectivity specifications for duplexer filters are very demanding, leading to them being expensive, heavy parts.

In a previous proposal, United States patent specification number U.S. Pat. No. 6,288,679, antenna elements of a multilayer planar structure are described, having transmit-receive frequency selectivity, and being particularly suitable for use in base stations.

British patent specification number GB 1,236,529 describes a dish antenna having a dual polarized feed horn to give improved transmit-receive isolation.

One previously proposed antenna element for use in base station antennas is described in United States patent specification number U.S. Pat. No. 6,995,732 and a paper by Wagner et al, “Universal broadband antenna elements employing metallized plastics technology”, 34th European Microwave Conference, 2004, pp. 833-6. The antenna element structures described in these references are based on the crossed dipole principle. Various configurations are shown which involve a continuous loop with alternating constrictions and bulges to define, for example, an open cross shape. It is suggested that these may be fabricated by injection molding to produce a metallized plastic component.

### BRIEF SUMMARY OF THE INVENTION

According to an aspect of the invention an antenna element comprises a surround of substantially circular cross-section and a plurality of feed sections electrically connected to the surround and extensive substantially radially and inwardly from it. The surround may have an exactly circular cross-section or could be elliptical, for example. An antenna element having this structure is mechanically robust, which is particularly important during installation, whether it is to be operated individually or as part of an array, and for use in challenging environments. Additionally, the structure may have a very high radiation efficiency, because it exhibits low-magnitude current peaks, resulting in low conductive losses, and no dielectric material need be included, except for air that surrounds it, resulting in almost zero dielectric losses.

In one embodiment, the surround is cylindrical. The depth of a cylindrical surround provides increased robustness and stability compared to a ring-shaped surround. Additionally, it permits the feed sections to be located at different distances from the edge of the cylinder, allowing them to be more precisely positioned for a particular frequency of operation. The cylindrical surround may extend, at least at parts of its circumference, to a ground plane on which it is mounted.

There may be four feed sections arranged in orthogonal pairs. One pair of feed sections on the same diameter may operate at one frequency and the other pair aligned along another diameter at another frequency.

The antenna element may be required to transmit and receive signals at different frequency bands, for example, at a base station of a wireless cellular communications system. In a conventional arrangement, the frequency range may be split using a duplexer filter, which provides protection for components of the receiving path which might otherwise be damaged if subjected to relatively high power transmissions. In an embodiment of the invention, the antenna element may be configured to provide frequency selective behavior. Thus, the requirements for the duplexer filter need not be so stringent while still providing the required level of protection of the receiver from transmitted signals at high power. The frequency selectivity for splitting the frequency range into the transmission band and reception band, may thus be achieved to a significant extent by the antenna element structure itself. Consequently, losses may thus be reduced, leading to an improvement in the reception sensitivity and the effective transmitted power. It also thus makes the remaining duplexer functionality easier to realize.

The antenna element may be used for dual-polarization, dual-frequency operation or a combination of them.

The antenna element may be a single integral component that includes the feed sections and the surround. The component could, for example, be manufactured using injection molding techniques, allowing many antenna elements to be produced with high repeatability, accuracy and at low cost. Many materials are suitable for use in injection molding. The antenna element may be of molded metallized plastic. This provides a lightweight component with the necessary electrically conductive properties. It is thus particularly suitable for applications where an antenna arrangement includes a plurality of the antenna elements arranged in array, such as one to be mounted on a wireless communications base station mast, for example. In another embodiment, the antenna element is cast from metal, which again may be done to produce a single component incorporating both the surround and the feed sections. Casting is also a suitable technique for large-scale production, hence enabling manufacture of antenna elements at low cost.

In one embodiment, the antenna element includes support posts arranged substantially perpendicular to the direction in which the feed sections are extensive and connected to the feed sections. The support posts may be electrically connected to the feed sections to form part of a signal path between the feed sections and circuitry associated with the element. The ends of the support posts remote from the feed sections may additionally include laterally extensive stubs mounted on a ground plane. These provide additional mechanical support for fixing the antenna element in position. The surround, feed sections, support posts and laterally extensive stubs may all be included together as a single integral component.

The antenna element may be surface mounted on a ground plane. Surface mount technology allows automated and accurate placement of an antenna element, and is particularly advantageous where a large number of antenna elements are used as an array of an antenna arrangement, for example. The support provided by the circular surround of an antenna element makes the design particularly mechanically stable, and thus suitable for such assembly techniques, and this is enhanced where the parts of the element are included as a single integral component. The antenna element, or elements, may be mounted on a ground plane defined by a metallization layer on a printed circuit board (PCB). The printed circuit board may also carry circuitry, for example, a balun connected to the antenna element, and other components on the opposite side to that one which the antenna element is mounted, or in layers of the PCB where the PCB is a multilayer board. A balun is a balanced-to-unbalanced converter, or 180° hybrid, and is used to balance the feeds.

According to another aspect of the invention, an antenna arrangement includes at least one antenna element comprising a surround of substantially circular cross-section and a plurality of feed sections electrically connected to the surround and extensive inwardly from it in a substantially radial direction.

According to another aspect of the invention, a wireless communications base station comprises: a mast-mounted antenna array, the array including a plurality of antenna elements, each antenna element comprising a surround of substantially circular cross-section and a plurality of feed sections electrically connected to the surround and extensive inwardly from it in a substantially radial direction; a transmit path for directing signals for transmission at a first frequency to the antenna array; and a receive path for directing signals received by the antenna array at a second different frequency, and wherein antenna elements of the array are frequency selective for transmission and reception.

### BRIEF DESCRIPTION OF THE DRAWINGS

Some embodiments in accordance with the present invention will now be described by way of example only, and with reference to the accompanying drawings, in which:

FIG. 1 schematically illustrates an antenna element in accordance with the invention;

FIG. 2 schematically illustrates an antenna element in accordance with the invention;

FIG. 3 schematically illustrates another antenna element in accordance with the invention;

FIG. 4 schematically illustrates an antenna element in accordance with the invention;

FIG. 5 is a schematic explanatory diagram relating to the operation of the antenna element shown in FIG. 4;

FIG. 6 is a schematic circuit relating to the operation of the antenna element shown in FIG. 4;

FIG. 7 is a schematic explanatory diagram relating to the operation of the antenna element shown in FIG. 4; and

FIG. 8 schematically illustrates a base station in accordance with the invention.

### DETAILED DESCRIPTION

With reference to FIG. 1, an antenna element 1 comprises a circular cross-section surround 2 and four orthogonal feed sections 3, 4, 5 and 6, which are radially extensive inwardly of the support 2 and electrically connected to it. Support posts 7, 8, 9 and 10 are connected to the free ends of the feed sections 3, 4, 5, and 6. The surround 2, feed sections 3, 4, 5 and 6, and support posts 7, 8, 9 and 10 are all part of a single integral component, which in this embodiment is of injection molded metallized plastic. The antenna element 1 is located over a conductive ground plane 11. The support posts 7, 8, 9 and 10, are insulated from the ground plane 11 and, in addition to supporting the antenna element and fixing it in position, also provide signal paths for transmitted and received signals radiated and received by the antenna element 1. This is a broadband structure and based on the crossed dipole principle. It shows dual orthogonal polarization, that is, horizontal plus vertical polarization, or +/−45 degrees, or left-hand/right-hand circular or elliptical polarization.

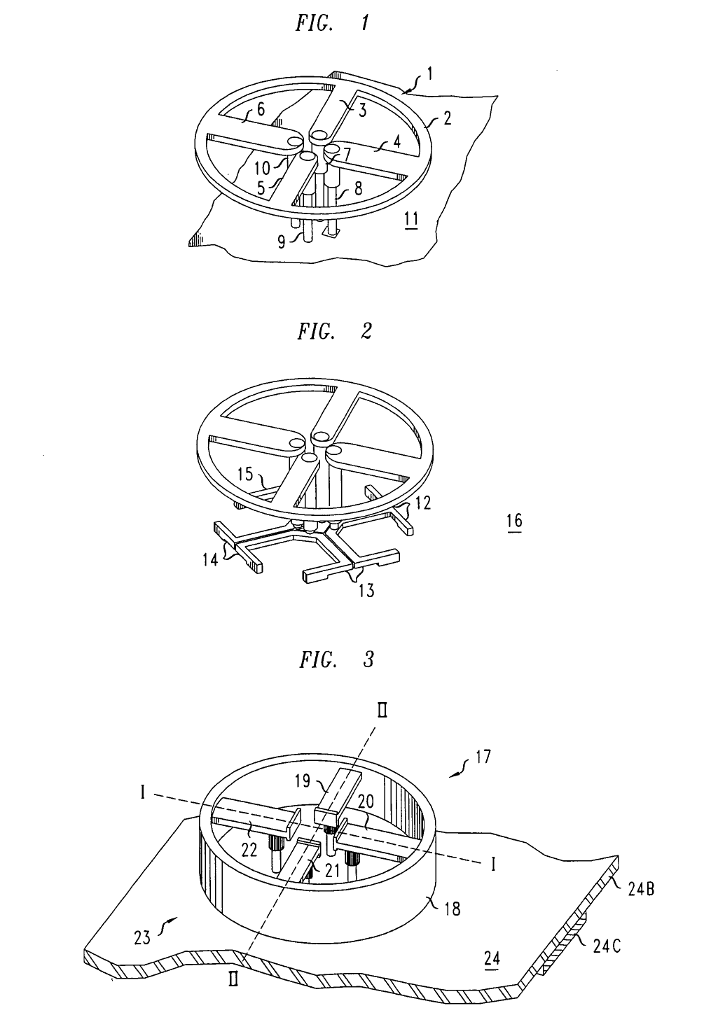

With reference to FIG. 2, an antenna element, similar to that shown in FIG. 1, also includes eight lateral stubs 12, 13, 14 and 15, grounded at their ends to the ground plane 16, to provide additional mechanical stability. The stubs 12, 13, 14 and 15 are formed integrally with the surround and feed sections. In this embodiment, the antenna element is made from cast metal but it could alternatively be of metallized plastic.

With reference to FIG. 3, an antenna element 17 includes a cylindrical surround 18 and four feed sections 19, 20, 21 and 22. There are two polarization and symmetry planes, shown as I-I and II-II. The antenna element exhibits dual orthogonal polarization, for example, horizontal plus vertical, or +/−45 degrees, or left-hand/right-hand circular/elliptical. The antenna element is located on a ground plane 23, defined by a metallization layer 24 on a PCB. The other surface of the PCB carries associated circuitry, such that making up baluns.

The antenna elements illustrated in FIGS. 1 to 3 may be adapted for single polarization, but transmit-receive selective, instead of using them as dual polarized at a given frequency band. By connecting the transmit path on one balanced pair of feeds (one polarization), and the receive path on the other balanced pair of feeds (the other polarization), one obtains a low coupling only between transmit and receive paths. In fact, because transmit and receive paths use orthogonal polarizations, the coupling is zero as long as the two perpendicular symmetries of the structure are kept. In practice, the neighborhood of the antenna element will break those symmetries, leading to some coupling between transmit and receive paths. Decoupling is achieved even if transmit and receive frequency bands partially, or even fully, overlap.

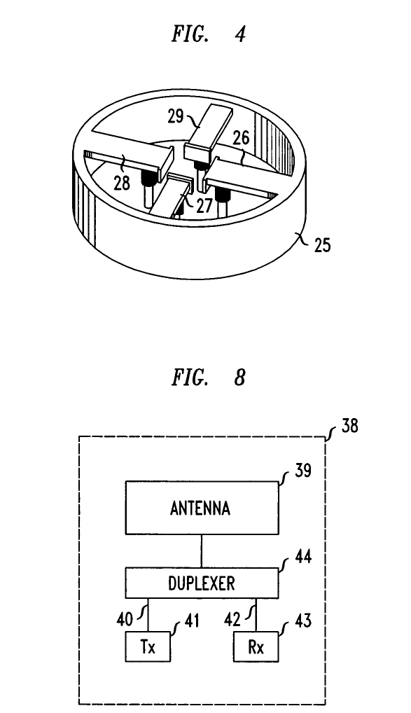

An antenna element shown in FIG. 4 is a modified version of that shown in FIG. 3. The antenna element of FIG. 4 provides slightly separated transmit and receive frequency bands. The antenna element includes a cylindrical surround 25 and four feed sections 26, 27, 28 and 29. One pair of feed sections 26 and 28 is located at the top edge of the cylindrical surround 25, as shown. The other pair of feed sections 27 and 29 is positioned a distance from the top edge of the cylindrical surround 25. As the latter pair, feed sections 27 and 29, is located nearer to the ground plane, it is selective for a higher frequency than the other pair, feed sections 26 and 28.

The antenna element of FIG. 4 is matched for transmit frequencies if driven by the transmit pair of feeds, and matched for receive frequencies if driven by the receive pair of feeds. The 90° rotational symmetry of the structure is destroyed but the two perpendicular symmetry planes are retained. As a result, the decoupling between transmit and receive paths is increased in practice, because the decoupling due to the different matching bandwidths at transmit and receive bands, is added to the polarization orthogonality decoupling outlined above.

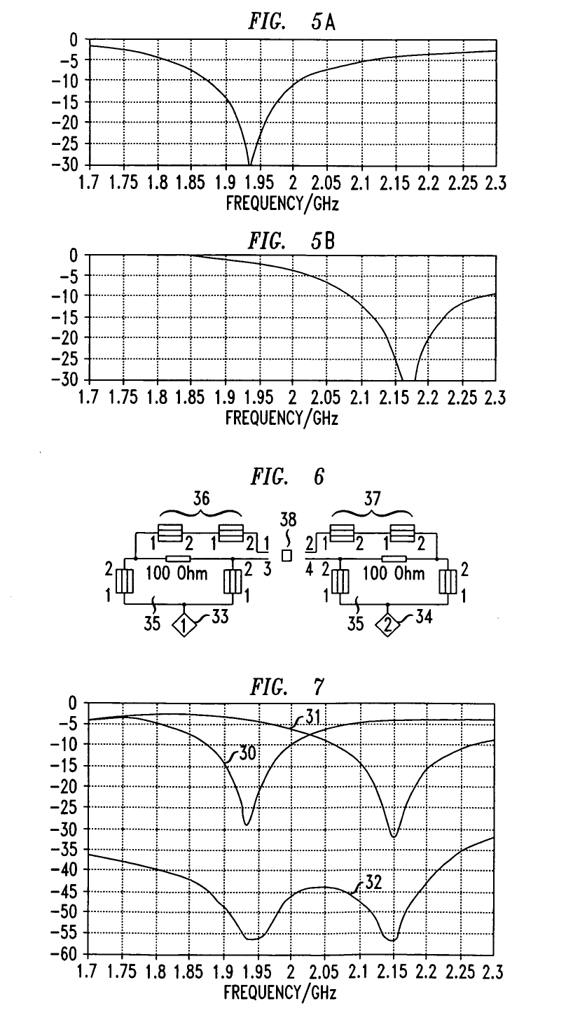

FIGS. 5(a) and (b) illustrate the matching of the antenna element of FIG. 4 at two different frequencies, these being 1.9 GHz and 2.1 GHz, assuming a perfectly balanced feed at all frequencies. Using a more realistic feeding structure, for example as shown in FIG. 6, the frequency response shown in FIG. 7 is obtained, with the two frequency matching curves being shown as lines 30 and 31 and low coupling between the two pairs of feed sections being illustrated by line 32. The decoupling due to polarization orthogonality is not perfect because the baluns included are not perfect nor frequency independent. However, the about 45 dB decoupling due to polarization orthogonality is increased at the transmit and receive frequency bands by about 10-15 db due to the frequency characteristics of the respective antenna match. The circuit shown in FIG. 6 includes two ports 33 and 34, a power divider 35, two pairs of 90 degree lines 36 and 37 and the antenna element 37.

A number of the antenna elements of any of the above described embodiments may be combined to form an array. The robustness, performance and potential lightweight nature of the antenna elements makes them particularly suitable for use in a telecommunications base station 38, as illustrated in FIG. 8. Antenna elements similar to that shown in FIG. 4 are combined to provide a mast-mounted antenna arrangement 39. The base station 38 includes a transmit path 40, having transmit circuitry 41, for directing signals for transmission at a first frequency to the antenna arrangement 39 and a receive path 42, having receive circuitry 43, for directing signals received by the antenna arrangement 39 at a second different frequency. As the antenna elements of the antenna arrangement 39 are frequency selective for transmission and reception, the operating requirements of a duplexer 44 may be relaxed compared to those of a conventional arrangement.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

1. An antenna element comprising an electrically continuous surround of substantially circular cross-section and a plurality of feed sections electrically connected to the surround and extensive substantially radially and inwardly from the surround, the plurality of feed sections and surround being included in a single integrally-formed component and the plurality of feed sections including four feed sections arranged as two orthogonal pairs.

2. (canceled)

3. The antenna element as claimed in claim 1 and wherein the component is injection molded.

4. The antenna element as claimed in claim 1 and wherein the component, is of metallized plastic.

5. The antenna element as claimed in claim 1 and wherein the component is of cast metal.

6. (canceled)

7. The antenna element as claimed in claim 1 and configured to provide dual-polarized operation.

8. The antenna element as claimed in claim 1 configured to provide frequency selective behavior between transmitted and received radiation.

9. The antenna element as claimed in claim 1 and including support posts arranged substantially perpendicular to the direction in which the feed sections are extensive and connected to the feed sections.

10. The antenna element as claimed in claim 9 and wherein the support posts are electrically connected to the feed sections and form part of a signal path between the feed sections and circuitry associated with the antenna element.

11. The antenna element as claimed in claim 9 and wherein the ends of the support posts remote from the feed sections include laterally extensive stubs mounted on a ground plane.

12. The antenna element as claimed in claim 11 and wherein the surround, feed sections, support posts and laterally extensive stubs are included as a single integrally-formed component.

13. The antenna element as claimed in claim 1 and wherein the antenna element is surface mounted on a ground plane.

14. The antenna element as claimed in claim 13 and wherein the surround is cylindrical and extends, at least at a part of the circumference of the surround, to the ground plane.

15. The antenna element as claimed in claim 1 and wherein the antenna element is mounted on a ground plane defined by a metallization layer on a printed circuit board.

16. The antenna element as claimed in claim 15 and wherein the printed circuit board includes a balun connected to the antenna element.

17. An antenna arrangement including at least one antenna element comprising an electrically continuous surround of substantially circular cross-section and a plurality of feed sections electrically connected to the surround and extensive inwardly from the surround in a substantially radial direction, the plurality of feed sections and surround being included in a single integrally-formed component and the plurality of feed sections including four feed sections arranged as two orthogonal pairs.

18. An antenna arrangement as claimed in claim 17 and including an array of antenna elements mounted on a ground plane, each antenna element comprising: a surround of substantially circular cross-section and a plurality of feed sections electrically connected to the surround and extensive inwardly from the surround in a substantially radial direction, the plurality of feed sections and surround being included in a single integrally-formed component and the plurality of feed sections including four feed sections arranged as two orthogonal pairs.

19. An antenna arrangement as claimed in claim 18 and wherein the antenna elements of the array are of molded metallized plastic.

20. A wireless communications base station comprising:
a mast-mounted antenna array, the array including a plurality of antenna elements, each antenna element comprising: an electrically continuous surround of substantially circular cross-section and a plurality of feed sections electrically connected to the surround and extensive inwardly from the surround in a substantially radial direction, the plurality of feed sections and surround being included in a single integrally-formed component and the plurality of feed sections including four feed sections arranged as two orthogonal pairs; a transmit path for directing signals for transmission at a first frequency to the antenna array; and a receive path for directing signals received by the antenna array at a second different frequency, and wherein antenna elements of the array are frequency selective for transmission and reception.
